(19) United States
(12) Patent Application Publication
(10) Pub. No.: US 2009/0010003 A1
(43) Pub. Date: Jan. 8, 2009

(54) LUMINAIRE

(76) Inventor: Martin Kirsten, Burecheid (DE)

Correspondence Address: BERENATO, WHITE & STAVISH, LLC, 6550 ROCK SPRING DRIVE, SUITE 240, BETHESDA, MD, 20817, US

(21) Appl. No.: 12/143,154

(22) Filed: Jun. 20, 2008

Related U.S. Application Data
(60) Provisional application No. 60/929,870, filed on Jul. 16, 2007.

(30) Foreign Application Priority Data
Jul. 3, 2007 (EP) 07012929.1

(51) Int. Cl. F21V 29/00

(52) U.S. Cl. 362/294

(57) ABSTRACT

The invention relates to a luminaire having a reflector that comprises an upper reflector rear wall and reflector side walls that define a lower light exit opening, and having a high-pressure discharge lamp having an burner that is arranged inside the reflector, there being present in the reflector rear wall at least one cutout that enables air and radiation to exit from the reflector, and in the region of the reflector side walls, openings being present that enable ambient air to enter the reflector.

### CROSS-REFERENCE TO RELATED APPLICATIONS AND CLAIM TO PRIORITY

This application is related to application no. 07 012 929.1, filed Jul. 3, 2007, in the European Patent Office and provisional application No. 60/929,870, filed Jul. 16, 2007, in the United States Patent and Trademark Office, the disclosures of which are incorporated herein by reference and to which priority is claimed.

### FIELD OF THE INVENTION

The present invention relates to a luminaire having a reflector that comprises an upper reflector rear wall and reflector side walls that define a lower light exit opening, and having a high-pressure discharge lamp having a burner that is arranged inside the reflector.

### BACKGROUND OF THE INVENTION

A luminaire of this kind is disclosed, for example, in EP 1 225 390 A1. The interior luminaire described is equipped with a reflector that encompasses an upper reflector rear wall as well as reflector side walls. The reflector side walls define a light exit opening on the lower side of the reflector. The interior luminaire comprises a high-pressure discharge lamp whose burner is arranged in a horizontal operating position inside the reflector.

Closure plates that close off the light exit opening are sometimes provided in such luminaires. These plates are embodied to be transparent to radiation, and they can additionally have filter properties so that specific radiation components are absorbed or reflected. Luminaires having filters are used in particular for the illumination of merchandise presentation surfaces.

Attempts have been made in recent years to increase the output of luminaires and at the same time reduce their dimensions. For example, high-pressure discharge lamps have been developed that are much smaller than the lamps used just a few years ago. The dimensions of the reflectors have also been reduced for adaptation to the smaller high-pressure discharge lamps now obtainable, although unexpected problems have arisen. For example, it has been found that the burners, in particular, of the high-pressure discharge lamps become too hot if they are operated while arranged inside a reflector that has been made smaller. This effect is even more considerably intensified if the light exit opening of the reflector is equipped with a closure plate. An excessively high burner temperature not only reduces the light output of the high-pressure discharge lamps but also decreases its overall service life.

As a consequence, it has not hitherto been possible to reduce the dimensions of the reflector to the same extent as those of the high-pressure discharge lamp, i.e. it is still necessary, in order to prevent overheating of the burner, to use a reflector that is disproportionately large as compared with the high-pressure discharge lamp.

### SUMMARY OF THE INVENTION

It is therefore an object of the present invention further to develop a luminaire of the kind cited initially so that its overall size can be further reduced as compared with luminaires known in the existing art, without resulting in an impairment of light output.

This object is achieved, according to the present invention, in that there is present in the reflector rear wall at least one cutout that enables air and radiation to exit from the reflector; and in the region of the reflector side walls, openings are present that enable ambient air to enter the reflector.

The basic idea of the invention is to configure, in two different regions of the reflector, cutouts or openings that enable air to enter from the surrounding area into the reflector, and enable air and radiation of the light source to exit from the reflector. The air entry openings are configured in the region of the reflector side walls, and the air exit openings in the reflector rear wall. Incoming air is heated by the hot burner of the high-pressure discharge lamp so that because of its elevated temperature, it rises upward in the reflector. It then exits from the cutout or cutouts in the reflector rear wall. A chimney effect occurs, which results in high air throughput through the reflector. The air flow through the reflector causes cooling of the burner of the high-pressure discharge lamp, so that the dimensions of the reflector can be adapted to the proportions of the high-pressure discharge lamp with no risk of overheating of the burner.

According to a first embodiment of the invention, provision is made that the light exit opening is closed off with a closure plate that is transparent to radiation. The high-pressure discharge lamp is thereby shielded with respect to the surrounding area, so that on the one hand damage thereto is prevented, and on the other hand in the event of destruction of the high-pressure discharge lamp, injury to persons by flying chips is precluded.

In a further embodiment of the invention, the cutout or cutouts are configured in a region of the reflector rear wall located opposite the burner. It is advantageous in this context that direct reflection of radiation back onto the burner, which also contributes to heating of the burner, is reduced. In addition, in this case the heated air can exit from the reflector directly above the hot burner, so that particularly good ventilation, and therefore also improved cooling of the burner, is achieved.

It is likewise possible for the cutout or cutouts to have a shape and size that are substantially adapted to the contour of the burner. In this case this ensures that direct radiation back onto the burner is minimized, while at the same time the reflective output of the reflector is at a high level.

A further embodiment provides that the openings are configured in the lower third of the reflector side walls, above the light exit opening. The reason is that it has been found that in this case, the air entering through the openings for the most part directly strikes the burner of the high-pressure discharge lamp, and thus cools it even more intensely. The consequence of this is that the operating temperature of the high-pressure discharge lamp is further lowered, resulting in an increase in efficiency.

In a refinement of the invention, provision is made for configuring the openings in the reflector side walls in a ring shape. For example, the openings can in particular be arranged in the reflector side walls in symmetrically spaced-apart fashion. This advantageously makes possible homogeneous entry of air from all sides into the reflector, so that a uniform temperature distribution inside the reflector is achieved, and the burner of the high-pressure discharge lamp experiences uniform cooling from all sides.

It is likewise possible for the openings to be configured as an at least partially circumferential gap between the lower end region of the reflector side walls and the closure plate.

A preferred embodiment of the invention provides for a facing that encloses the reflector, and for an installation frame in which the facing is held. A gap that enables air to flow in is configured between the facing and the installation frame. The installation frame makes it possible, in particular, to mount the luminaire in ceilings or walls in simple fashion. This ensures that the air necessary for cooling the luminaire can travel to the reflector and in particular to the openings in the region of the reflector side walls.

The openings in the region of the reflector side walls can be configured so that they enable the entry of air, which flows through the gap between the facing and the installation frame and then over the edge of the facing in the direction of the reflector. The openings can be configured in the region of the facing.

It is likewise possible for the reflector to be configured so as to generate a bat-wing light distribution. This is advantageous in particular when the luminaire is to be used to illuminate elongated merchandise presentation surfaces.

In a refinement of the invention, provision is made to equip the reflector rear wall and/or the reflector side walls with a diffuse surface that reflects the incident radiation in scattered fashion. This additionally decreases radiation back from the reflector onto the burner of the high-pressure discharge lamp.

According to a further embodiment of the invention, the closure plate can be embodied as a filter that absorbs or reflects portions of the radiation. The light spectrum emitted by the luminaire can thereby easily be adapted. For example, specific color components or radiation that are undesirable, for example for the illumination of merchandise presentation surfaces, can be filtered out or reflected.

The burner of the high-pressure discharge lamp can be arranged in a horizontal or vertical operating position inside the reflector.

### BRIEF DESCRIPTION OF THE DRAWINGS

The invention will be described below in detail with reference to the drawings, referring to two exemplifying embodiments. In the drawings:

FIG. 1 schematically depicts a first luminaire according to the present invention;

FIG. 2 is a side view of a portion of the luminaire of FIG. 1; and

FIG. 3 is a side view of a second luminaire according to the present invention.

### DETAILED DESCRIPTION OF THE PREFERRED EMBODIMENT(S)

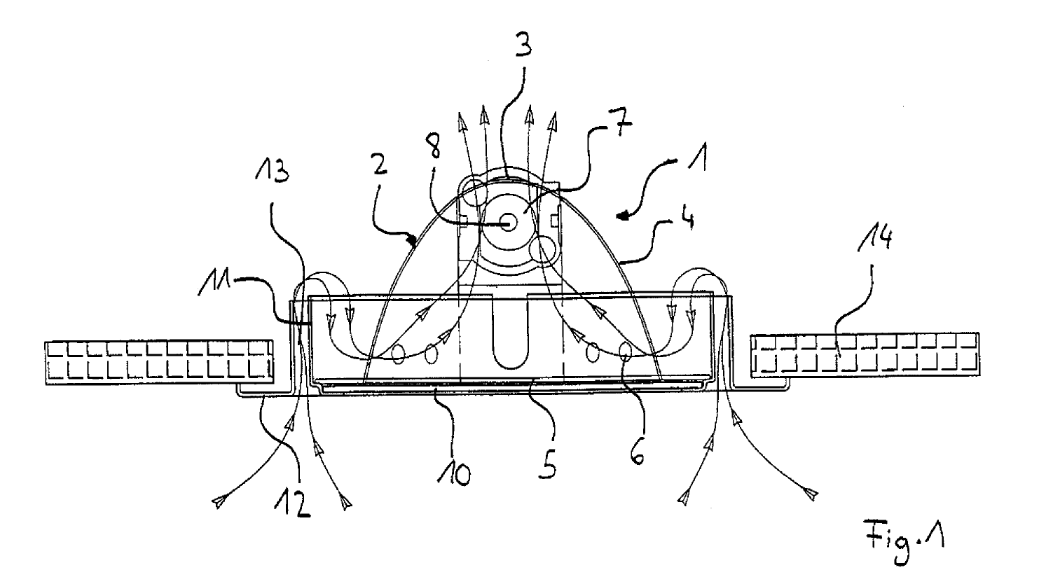

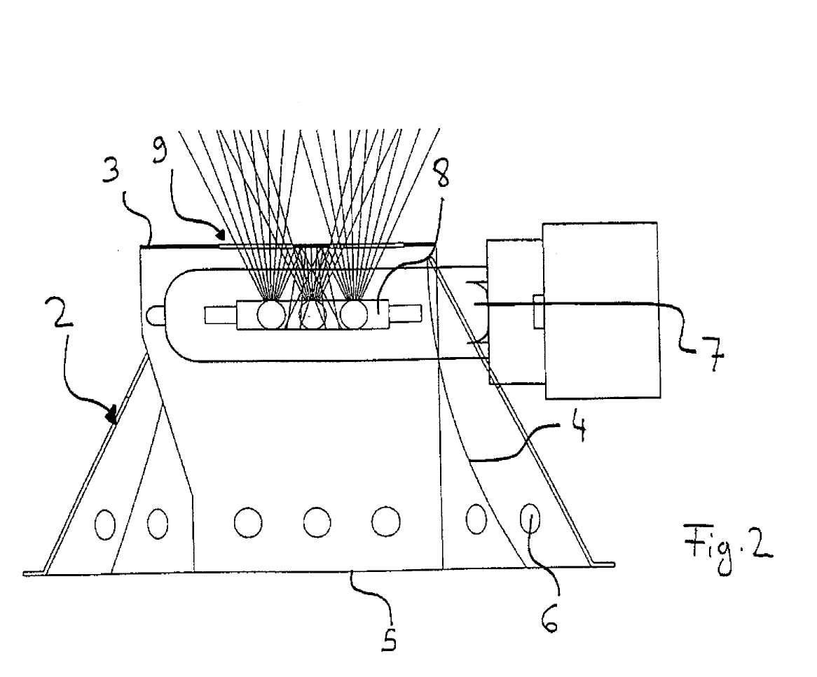

FIGS. 1 and 2 schematically depict a first luminaire 1 according to the present invention. First luminaire 1 comprises a reflector 2 that is equipped with a reflector rear wall 3 and with reflector side walls 4. Reflector side walls 4 define a lower light exit opening 5 of reflector 3. A plurality of (in this case) circular openings 6 are configured in the lower third of reflector side walls 4, above light exit opening 5, in a ring shape.

First luminaire 1 encompasses a high-pressure discharge lamp 7 that is equipped with an burner 8. Burner 8 is arranged in a horizontal operating position inside reflector 2, parallel to and at a distance from reflector rear wall 3. Configured in a region of reflector rear wall 3 located opposite burner 8 are two cutouts 9 that are together adapted, in terms of their shape and size, to the contour of burner 8.

Light exit opening 5 is closed off by a filter 10 that is configured to filter out specific components of the radiation emitted by high-pressure discharge lamp 7.

Reflector 2 is enclosed by a facing 11 that in turn is held in an installation frame 12. Configured between facing 11 and installation frame 12 is a gap 13 that enables air to flow in. Installation frame 12 comprises holding burners (not shown in the drawing) that enable releasable attachment of installation frame 10 to wall regions 14.

During the operation of luminaire 1, as shown in FIG. 1, air flows from the surrounding area through gap 13 into luminaire 1, and then over the edge of facing 11 in the direction of reflector 2. Air enters the interior of reflector 2 through openings 6, such that a substantial portion strikes burner 8. The air contributes to the cooling of burner 8 by receiving heat from it and by being itself heated.

The heated air flows, inside reflector 2, toward reflector rear wall 3, and then exits through cutouts 9 in reflector rear wall 3. The path described here of air into and out of luminaire 1 is made evident in FIG. 1 by arrows.

The arrangement of gap 13, openings 6, and cutouts 9 results in a chimney effect, so that a particularly large amount of air flows through the luminaire, resulting in intensive cooling of burner 7 [sic].

In addition, cutouts 9 in reflector rear wall 3 are configured here in such a way that only a small portion of radiation is reflected from reflector rear wall 3 directly onto burner 8. A large portion of the radiation that might be reflected back onto burner 8 thus exits from the reflector through cutouts 9. This radiation is therefore lost from luminaire 1, but it has been found that this loss of luminosity is more than compensated for by improved illumination output from burner 8 because of its lower temperature.

Considered globally, in the context of the first luminaire 1 according to the present invention, reflector 2 can be adapted exactly to the size of high-pressure discharge lamp 7, since this ensures that burner 8 is sufficiently cooled despite the small dimensions of reflector 2.

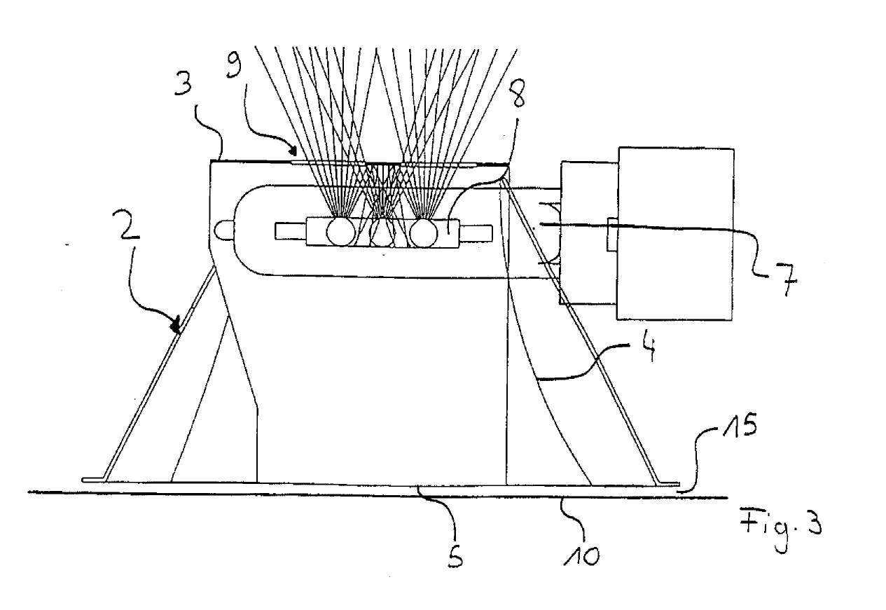

FIG. 3 is a side view of a second luminaire 1 according to the present invention. Second luminaire 1 is substantially identical to first luminaire 1 shown in FIGS. 1 and 2. Identical parts are therefore given the same reference numbers. Only the differences between the first and second luminaire will be described below.

Luminaire 1 of FIG. 3 has no openings 6 in reflector side walls 4. Instead, there is configured, between the lower end region of reflector side wails 4 and closure plate 10, an at least partially circumferential gap 15 through which air can enter reflector 2 from the surrounding area. Closure plate 10 is attached to the lower end regions of reflector side walls 4 via struts (not shown in the drawings).

Air also flows through second luminaire 1 so that burner 8 of high-pressure discharge lamp 7 is sufficiently cooled.

We claim:

1. A luminaire (1) having a reflector (2) that comprises an upper reflector rear wall (3) and reflector side walls (4) that define a lower light exit opening (5), and having a high-pressure discharge lamp (7) having an burner (8) that is arranged inside the reflector (2),
wherein there is present in the reflector rear wall (3) at least one cutout (9) that enables air and radiation to exit from the reflector (2); and in the region of the reflector side walls (4), openings (13) are present that enable ambient air to enter the reflector (2).

2. The luminaire (1) according to claim 1, wherein the light exit opening (5) is closed off with a closure plate (10) that is embodied to be transparent to radiation.

3. The luminaire (1) according to claim 1, wherein the cutout or cutouts (9) are configured in a region of the reflector rear wall (3) located opposite the burner (8).

4. The luminaire (1) according to claim 3, wherein the cutout or cutouts (9) have a shape and size that are substantially adapted to the contour of the burner (8).

5. The luminaire (1) according to claim 1, wherein the openings (6) are configured in the lower third of the reflector side walls (4), above the light exit opening (5).

6. The luminaire (1) according to claim 1, wherein the openings (6) are configured in the reflector side walls (4) in a ring shape.

7. The luminaire (1) according to claim 2, wherein the openings (6) are configured as an at least partially circumferential gap (15) between the lower end region of the reflector side walls (4) and the closure plate (10).

8. The luminaire (1) according to claim 1, wherein a facing (11) that encloses the reflector (2), and an installation frame (12) in which the facing (11) is held, are provided; and at least one opening, in the form of a gap (13) that permits air to flow in, is configured between the facing (11) and the installation frame (12).

9. The luminaire (1) according to claim 8, wherein the openings (6) in the reflector side walls (4) are configured in order to enable the entry of air, which flows through the gap (13) between the facing (11) and the installation frame (12) and then over the edge of the facing (11) in the direction of the reflector (2).

10. The luminaire (1) according to claim 9, wherein the openings (6) are configured in the reflector side walls (4) in the region of the facing (11).

11. The luminaire (1) according to claim 1, wherein the reflector (2) is configured so as to generate a bat-wing light distribution.

12. The luminaire (1) according to claim 1, wherein the reflector rear wall (3) and/or the reflector side walls (4) have a diffuse surface that reflects incident radiation in scattered fashion.

13. The luminaire (1) according to claim 13, wherein the closure plate (10) is embodied as a filter that absorbs or reflects portions of the radiation.

14. The luminaire (1) according to claim 1, wherein the burner (8) of the high-pressure discharge lamp (7) is arranged in a horizontal or vertical operating position inside the reflector (2).

15. The luminaire (1) according to claim 2, wherein the openings (6) are configured as an at least partially circumferential gap (15) between the lower end region of the reflector side walls (4) and the closure plate (10).

16. A luminaire (1) having a reflector (2) that comprises an upper reflector rear wall (3) and reflector side walls (4) that define a lower light exit opening (5), and having a high-pressure discharge lamp (7) having an burner (8) that is arranged inside the reflector (2),
wherein there is present in the reflector rear wall (3) at least one cutout (9) that enables air and radiation to exit from the reflector (2); and in the region of the reflector side walls (4), openings (13) are present that enable ambient air to enter the reflector (2); and
wherein openings (6) in the reflector side walls (4) are configured in order to enable the entry of air, which flows through the gap (13) between the facing (11) and the installation frame (12) and then over the edge of the facing (11) in the direction of the reflector (2).

17. The luminaire (1) according to claim 16, wherein the openings (6) in the reflector side walls (4) are configured in order to enable the entry of air, which flows through the gap (13) between the facing (11) and the installation frame (12) and then over the edge of the facing (11) in the direction of the reflector (2).

18. The luminaire (1) according to claim 17, wherein the openings (6) are configured in the reflector side walls (4) in the region of the facing (11).
